(19) United States
(12) Patent Application Publication
(10) Pub. No.: US 2012/0196058 A1
(43) Pub. Date: Aug. 2, 2012

(54) Method For Colouring Anodically Oxidised Aluminum Surfaces

(75) Inventors: Marcus Kleinert, Koenigstein/Taunus (DE); Harald Oswald, Hofheim am Taunus (DE); Elena Weinbender, Riedstadt (DE); Olivier Roche, Safenwil (CH)

(73) Assignee: CLARIANT FINANCE (BVI) LIMITED, Tortola (VG)

(21) Appl. No.: 13/499,196

(22) PCT Filed: Sep. 9, 2010
(86) PCT No.: PCT/EP2010/005553

§ 371 Date: Mar. 29, 2012

(30) Foreign Application Priority Data
Sep. 30, 2009 (DE) 10 2009 043 762.2

(51) Int. Cl. B32B 15/04; D06P 3/80

(52) U.S. Cl. 428/34.1; 8/522; 428/469

(57) ABSTRACT

The invention relates to a process for adsorptive coloration of anodically oxidized surfaces of aluminum and/or aluminum alloys, characterized in that
a) an aqueous dyebath is provided, said aqueous dyebath containing an organic dye that fluoresces on irradiation with UV light of a wavelength between 300 and 400 nm, containing not more than 0.4 g/liter of alkaline earth metal ions and having a pH between 4.0 and 10,
b) said anodically formed surface is colored by immersion in and/or spraying with said dyebath (a) at a temperature between 10 and 50° C., and
c) the colored surface is sealed.

The invention relates to a process for adsorptive coloration of anodized aluminum surfaces with UV-active organic dyes.

Colored anodically formed layers of oxide are of immense industrial interest in the field of aluminum finishing by virtue of their protective effect against mechanical influences as well as to achieve decorative effects. The colored layer is inseparably connected to the aluminum. This is a fundamental difference with other methods of coloration, such as painting for example. Electrolytic coloration as well as adsorptive coloration are among the commonly known processes for coloring surfaces of aluminum and aluminum alloys. Adsorptive processes of coloration typically subsume coloration techniques wherein organic or inorganic dyes penetrate into the pores of the anodically formed layer of oxide, or are formed therein by chemical reaction, by single or repeated immersion in aqueous or nonaqueous dyeing solutions. Subsequently, the anodically formed layers of oxide are typically sealed at elevated temperatures in aqueous solution to close the pores in the oxide layer and irreversibly fix the dye in the layer. A typical adsorptive process of coloration with organic dyes is described for example in CH 685 119 A5. Temperatures between 55 and 65° C. and the presence of buffering substances, especially acetate buffer, are regarded therein as advantageous for coloration.

DE 38 25 213 A1 describes adsorptive colorations of aluminum surfaces being effected with organic dyes which are actually active in the UV, i.e., which fluoresce in UV light, examples being fluorescein or eosin, to obtain golden yellow and reddish colorations on the anodized sheet of aluminum respectively. However, when the exemplary embodiments were reproduced, it was found that the original UV activity of the dyes used had disappeared on the colored sheet of aluminum.

It is accordingly desired to provide anodically oxidized aluminum surfaces where the dye effectuates not just a visually appealing color with retention of the metallic character but also a fluorescence in UV light on the colored aluminum surface. A further object is that of providing a specific process for coloring aluminum oxide layers while preserving the UV activity of the dye used. There is a further desire for a very homogeneous, spotless coloration of the layer of aluminum oxide.

This object is surprisingly achieved by the hereinbelow-described process wherein certain aluminum coloration measures recommended in the prior art are changed or wholly avoided.

The invention accordingly provides a process for adsorptive coloration of anodically oxidized surfaces of aluminum and/or aluminum alloys, characterized in that
a) an aqueous dyebath is provided, said aqueous dyebath containing an organic dye that fluoresces on irradiation with UV light of a wavelength between 300 and 400 nm, containing not more than 0.4 g/liter of alkaline earth metal ions and having a pH between 4.0 and 10,
b) said anodically formed surface is colored by immersion in and/or spraying with said dyebath (a) at a temperature between 10 and 50° C., and
c) the colored surface is sealed.

The dyes used according to the invention are UV-active, i.e., they fluoresce on irradiation with UV light of a wavelength between 300 and 400 nm, especially at 366 nm.

Examples of such dyes are:
xanthenes, e.g., C.I. Acid Red 52 (C.I. No. 45100)
pyrenes, e.g., C.I. Solvent Green 7 (C.I. No. 59040)
methines, e.g., Basic Violet 21 (C.I. No. 48030)
stilbenes, e.g., C.I. Direct Yellow 106 (C.I. No. 40300)
coumarin (e.g., C.I. No. 551100)
cyanines (e.g., C.I. No. 48016)
oxazines (e.g., C.I. No. 51180)
uranines, e.g., C.I. Acid Yellow 73, C.I. 45350
C.I. Acid Yellow 245.

Dyebath concentration of dye depends on the desired intensity of hue, the thickness and the structure of the oxide layer. Preference is given to a concentration of 0.1 to 10 g, more preferably 0.5 to 7 g and especially 1 to 5 g of dye per liter of dyebath.

Surprisingly, the presence of alkaline earth metal ions, recommended in DE 38 25 213 A1 in particular, results in the production of inhomogeneous colorations with reduced UV activity, and therefore the addition or presence of alkaline earth metal ions at more than 400 mg and preferably at more than 100 mg per liter of dyebath shall be avoided in the process according to the invention.

Contrary to the dyeing temperatures of 60° C. or higher, which are recommended in the prior art, a dyeing temperature of 50° C. must not be exceeded in the process according to the invention in order that any quenching of UV activity may be prevented. Preferred dyeing temperatures lie between 20 and 40° C.

Dyebath pH lies between 4.0 and 10, preferably between 4.5 and 9.0, especially between 5.0 and 8.0 and most preferably between 5.2 and 7.0.

The pH can be set and maintained using monofunctional bases, such as LiOH, NaOH or KOH, ammonia, and also acids, such as sulfuric acid or nitric acid. Surprisingly, buffering with acetate ions, which is recommended in the prior art, was found to produce only very weak and low-lightfastness colorations, and so the addition of an acetate buffer in amounts needed for effective buffering should be avoided in the process of the present invention. It was more particularly observed that not more than 60 mg and preferably not more than 10 mg of acetate ions should be present per liter of dyebath.

Care must further be taken not to add substances such as acids, bases, salts or buffers which contain disruptive ions known from the prior art, for example phosphates, silicates, chlorides, fluorides and formate. The permissible concentration upper limits are advantageously 20 mg/l for phosphates, 6.2 mg/l for silicates, 10.0 mg/l for chlorides, 0.8 mg/l for fluorides and 10 mg/l for formate.

The process according to the invention can be carried out in the presence or in the absence of surfactants. However, it can be advantageous to add anionic and nonionic surfactants, preferably nonionic silicone surfactants, more preferably nonionic polyether-modified polydimethylsiloxanes, to the dyebath. The amount used thereof is advantageously 0.1 to 10 g, preferably 0.25 to 5 g and especially 0.1 to 2.5 g per liter of dyeing solution.

Dyeing time can be 5 to 45 minutes and is advantageously from 10 to 30 minutes. The immersion process is preferable.

Aluminum is to be understood as meaning not just purely aluminum but also its alloys which behave the same or similarly with regard to anodic oxidation. After adsorptive coloration, the oxide layers are subjected to known sealing processes. In sealing, anhydrous Al₂O₃ converts into hydrate, which occupies a larger volume and thereby closes the pores and prevents the color leaching out.

It is particularly advantageous to seal the oxide layer by treatment with hot water (about 95 to 100° C.) or water vapor. Using the familiar nickel salt sealing process leads to a minimization of UV activity of colored surfaces and therefore shall be avoided.

Sealing time is generally in the range from 1 to 5 minutes per micrometer of layer thickness.

The process according to the invention provides colored surfaces of aluminum which have a color in the visible wavelength region and a metallic brightness effect and are fluorescent under UV light (300-400 nm).

Homogeneously colored anodized surfaces of aluminum which are additionally UV-active, i.e., fluorescent in UV light and more particularly in 300-400 nm UV light, have hitherto not been described.

The present invention accordingly also provides an article comprising an anodically formed aluminum oxide layer dyed with a hue in the visible wavelength region of light by adsorptive coloration and fluorescent in UV light of a wavelength between 300 and 400 nm. The hue in the visible light can be yellow, orange, red, blue, green ranging to golden.

The present invention further provides an article comprising an anodically formed aluminum oxide layer dyed with a hue in the visible wavelength region of light by adsorptive coloration according to the above-described process and fluorescent in UV light of a wavelength between 300 and 400 nm. The hue in the visible light can be yellow, orange, red, blue, green ranging to golden.

Articles of this type are particularly suitable for producing corresponding optical or decorative effects, for example in casings of cell-phones, cosmetic articles, cameras, toy articles, flashlights, jewelry, buttons, belt buckles, disco club facilities, casings of music systems, picture frames, wall decorations, gift articles, beverage cans, but also for security applications, for example coatings on the original specimen as protection against forgeries and also signage, distinguishing marks, license plates and labels.

The fluorescent activity is optically assessed by visual evaluation against the internationally standardized gray scale to DIN 54001 and DIN EN ISO 105 A02, since the human eye responds extremely sensitively to perceived colors on high-reflectivity surfaces. Furthermore, gray scale assessment is independent of the particular dye. The scale consists of five pairs of gray color fields which each illustrate a visible difference and contrast in lightness. The highest contrast has grade 1, while there is no discernible contrast in the case of grade 5. When the classification according to the gray scale is applied to fluorescent activity, then:
grade 1 denotes: very strong UV activity
grade 2 denotes: strong UV activity
grade 3 denotes: medium UV activity
grade 4 denotes: weak UV activity
grade 5 denotes: no UV activity.

Using the scale in the measurement:

The dyed test panel and the gray scale are placed side by side on a planar support underneath a UV lamp, for example a 366 nm lamp. The visual difference between the contrast steps of the test panel (UV-active dye vs. quenched dye) is compared with the contrast steps of the gray scale. The grade is specified to be that number of the gray scale which is equal in magnitude to the contrast of the test panel.

Gray scales are commercially available, for example from Beuth Verlag GmbH, Berlin, in the form of convenient designs featuring a slider in a sleeve.

In the examples which follow, panels of AlMg₁ material No. 3.3315 as per DIN 1725P.1 were degreased in an aqueous solution containing 5% by weight of Anodal® DA-5 alkaline cleaner at 50° C. for 2 minutes.

The subsequent anodization was performed according to the direct current sulfuric acid process: 1.4 A/dm², at 19° C., treatment time 28 min, layer thickness about 11 to 13 μm. The panels were rinsed with deionized water.

Coloration: The panels were subsequently dyed as described in the examples which follow.

Sealing: The dyed surfaces were sealed in a water bath containing 2 ml/l of a scale inhibitor (Anodal® SH-1), pH 5.6, at 98° C. for about 30 min.

### EXAMPLE 1

C.I. Solvent Green 7, C.I. 59040, e.g., Sanolin® Pyranine Green, Clariant),

pH=5.5 (not buffered)

Dyeing temperature: 25° C.

Dyeing time: 10 min (immersion)

Influence of dye concentration:

0.5 g/l, homogeneous coloration, UV activity 4

1.0 g/l, homogeneous coloration, UV activity 3

2.0 g/l, homogeneous coloration, UV activity 4

5.0 g/l, homogeneous coloration, UV activity 4

### EXAMPLE 2

C.I. Acid Red 52, C.I. 45100, e.g., Sanolin® Rhodamine B, Clariant,

pH=5.6 (not buffered)

Dyeing temperature: 25° C.

Dyeing time: 10 min (immersion)

Influence of dye concentration:

1.25 g/l, homogeneous coloration, UV activity 3

2.5 g/l, homogeneous coloration, UV activity 4

5.0 g/l, homogeneous coloration, UV activity 4

### EXAMPLE 3

C.I. Acid Yellow 245, e.g., Duasyn® Fluorescent Yellow T liquid, Clariant;

pH=5.6 (not buffered)

Dyeing temperature: 25° C.

Dyeing time: 10 min (immersion)

Influence of dye concentration:

0.5 g/l, homogeneous coloration, UV activity 3

1.0 g/l, homogeneous coloration, UV activity 2-3

2.0 g/l, homogeneous coloration, UV activity 2

5.0 g/l, homogeneous coloration, UV activity 2

### EXAMPLE 4

Sanolin Pyranine Green, 5.0 g/l

Adding a surfactant from the group of nonionic polyether-modified polydimethyl-siloxanes, e.g., BYK® 346

pH=5.6 (not buffered)

Dyeing temperature: 25° C.

Dyeing time: 10 min (immersion).

Influence of BYK 346 surfactant concentration:

0.1 g/l, homogeneous coloration, UV activity 3-4

0.5 g/l, homogeneous coloration, UV activity 3

1.0 g/l, homogeneous coloration, UV activity 2

2.0 g/l, homogeneous coloration, UV activity 1-2

5.0 g/l, homogeneous coloration, UV activity 2

10.0 g/l, homogeneous coloration, UV activity 2-3

### EXAMPLE 5

Duasyn Fluorescent Yellow T liquid, 5.0 g/l

pH=5.6 (not buffered)

Dyeing temperature: 25° C.

Dyeing time: 10 min (immersion)

Influence of BYK 346 surfactant concentration:

0 g/l, homogeneous coloration, UV activity 2

2.0 g/l, homogeneous coloration, UV activity 1-2

### EXAMPLE 6

Sanolin Pyranine Green, 5.0 g/l

Dyeing temperature: 25° C.

Dyeing time: 10 min (immersion)

Influence of pH

pH=4.0 (not buffered); homogeneous coloration, UV activity 4-5;

pH=5.6 (not buffered); homogeneous coloration, UV activity 3;

pH=7.0 (not buffered); homogeneous coloration, UV activity 2;

pH=9.0 (not buffered); homogeneous coloration, UV activity 2;

pH=5.6 buffered with sodium acetate; homogeneous but very weak coloration,

UV activity 2, disappears after a few days;

pH=5.6 buffered with ammonium acetate; homogeneous but very weak

coloration, UV activity 2-3, disappears after a few days.

### EXAMPLE 7

Sanolin Rhodamine B, 2.5 g/l

Dyeing temperature: 25° C.

Dyeing time: 10 min (immersion)

pH=5.6 (not buffered); homogeneous coloration, UV activity 4;

pH=5.6 buffered with sodium acetate; homogeneous coloration, UV activity 5;

### EXAMPLE 8 (COMPARATIVE EXAMPLE)

### Presence of Alkaline Earth Metal Ions

Sanolin Rhodamine B 5 g/l+barium nitrate addition

pH=5.6 (not buffered)

Dyeing temperature: 25° C.

Dyeing time: 10 min

Barium nitrate 0.5 g/l; inhomogeneous coloration, UV activity 5

Barium nitrate 1 g/l; inhomogeneous coloration, UV activity 5

Barium nitrate 5 g/l; inhomogeneous coloration, UV activity 5

### EXAMPLE 9 (COMPARATIVE EXAMPLE)

### Dyeing at 60° C.

Sanolin Pyranine Green, 5.0 g/l

T=25° C., homogeneous coloration, UV activity 3

T=30° C., homogeneous coloration, UV activity 3

T=60° C., homogeneous coloration, UV activity 5

pH=5.5 (not buffered)

Dyeing time: 10 min

1. A process for adsorptive coloration of anodically oxidized surfaces of aluminum and/or aluminum alloys, comprising the steps of
a) providing an aqueous dyebath, said aqueous dyebath containing an organic dye that fluoresces on irradiation with UV light of a wavelength between 300 and 400 nm, containing not more than 0.4 g/liter of alkaline earth metal ions and having a pH between 4.0 and 10,
b) coloring said anodically formed surface by immersion in spraying with said dyebath (a), or both at a temperature between 10 and 50° C., and
c) sealing the colored surface.

2. The process as claimed in claim 1, wherein the organic dye is selected from the group consisting of xanthenes, pyrenes, methines, stilbenes, coumarins, cyanines, oxazines, uranines and C.I. Acid Yellow 245.

3. The process as claimed in claim 1, wherein the dyebath pH is between 5.2 and 7.0.

4. The process as claimed in claim 1, wherein the dyebath contains not more than 60 mg of acetate ions per liter of dyebath.

5. The process as claimed in claim 1, wherein the dyebath contains at least one anionic or nonionic surfactants.

6. The process as claimed in claim 1, wherein the dyebath contains a nonionic surfactant selected from the group of polyether-modified polydimethylsiloxanes.

7. The process as claimed in claim 1, wherein the colored surface is sealed by treatment with hot water or with water vapor.

8. An article comprising an anodically formed aluminum oxide layer dyed with a hue in the visible wavelength region of light by adsorptive coloration and fluorescent in UV light of a wavelength between 300 and 400 nm.

9. The article as claimed in claim 8, wherein the hue in the visible light is yellow, orange, red, blue, green or golden.

10. The article as claimed in claim 8 wherein the article is in the form of casings of cell-phones, cosmetic articles, cameras, toy articles, flashlights, jewelry, buttons, belt buckles, disco club facilities, casings of music systems, picture frames, wall decorations, gift articles, beverage cans, coatings for protection against forgeries in signage, distinguishing marks, license plates or labels.
